(19) United States
(12) Patent Application Publication
(10) Pub. No.: US 2025/0284293 A1
(43) Pub. Date: Sep. 11, 2025

(54) LOW POWER, HIGH RESILIENCY INTERNET OF FLYING THINGS NETWORK

(71) Applicant: University of Northern Iowa Research Foundation, Cedar Falls, IA (US)

(72) Inventors: Dheryta Jaisinghani, Cedar Falls, IA (US); Andrew Berns, Center Point, IA (US)

(73) Assignee: University of Northern Iowa Research Foundation, Cedar Falls, IA (US)

(21) Appl. No.: 19/037,831

(22) Filed: Jan. 27, 2025

Related U.S. Application Data
(60) Provisional application No. 63/561,502, filed on Mar. 5, 2024.

(51) Int. Cl. G05D 1/69; G05D 105/40; H04W 84/18

(52) U.S. Cl. CPC G05D 1/69; G05D 2105/40; H04W 84/18

(57) ABSTRACT

Embodiments of the disclosure relate to a mesh network. The mesh network includes a plurality of drones and a border router. The plurality of drones is configured to communicate with each other and with the border router over a first protocol. The first protocol uses IPV6 mesh connectivity at a first bandwidth. At least one drone of the plurality of drones operates as a router, and at least one drone of the plurality of drones operates as an end device. The router is configured to communicate with the border router and with the end device, and the end device is configured to communicate only with the router. The border router can be configured to communicate with an external network over a second protocol using a second bandwidth, and the second bandwidth can be greater than the first bandwidth.

### CROSS-REFERENCE TO RELATED PATENT APPLICATIONS

This patent application claims the benefit of U.S. Provisional Patent Application No. 63/561,502, filed Mar. 5, 2024, the entire teachings and disclosure of which are incorporated herein by reference thereto.

### FIELD OF THE INVENTION

This invention generally relates to mesh networks and, in particular, to mesh networks established across flying drones.

### BACKGROUND OF THE INVENTION

Flying robots, i.e., drones, are being implemented to help solve various day to day challenges. The global drone market is significantly growing and is predicted to be 279 billion U.S. dollars by 2032. In recent years, drones have spurred interest in Internet-of-Things (IoT) applications, thereby serving as a key enabler for various critical applications, such as automated infrastructure inspection, search and rescue operations, emergency and medical services, package delivery, and security and surveillance. When leveraging drones to solve a problem that is of IoT origin, it is termed as the Internet of Flying Things (IoFT). One major challenge in most of these applications is to enable seamless air-to-air network connectivity between these IoFT devices. Network connectivity of IoFT needs to not only be robust and power-efficient, but network connectivity should also auto-configure itself to satisfy the highly dynamic nature of IoFT where topology varies frequently.

Given the network dynamism, the routing strategies of traditional networks cannot be applied as-is for IoFT because the network needs to be highly resilient with robust failover mechanisms to deal with the incidents of outages. Thus, practical realization of an IoFT network requires judicious consideration of apt technology that satisfies the constraints of varying network topology, energy budget, and high availability.

Literature suggests both centralized and distributed approaches to establish and maintain IoFT networks that may operate in either infrastructure mode or adhoc/mesh mode, respectively. Distributed approaches are preferred over centralized ones, given the major drawback of single point failure for the latter. A multitude of technologies are available for establishing mesh networks-WiFi/IEEE 802.11s, Zigbee, BLE, and Thread to name a few. Traditional IEEE 802.11-based protocols suffer from some major drawbacks when applied to IoT networks. For example, such protocols primarily operate in infrastructure mode (and hence are not truly decentralized), WiFi devices are expensive, and the standard does not cater to low power requirements of IoT nodes. While able to operate in low power mode, the nodes with BLE and Zigbee cannot reach the cloud without deploying an external gateway.

Because of the lack of standardized protocols to develop IoT mesh networks, Amazon, Apple, Google, Zigbee and more than 200 companies together formed the Connectivity Standards Alliance. The alliance was launched on Nov. 3, 2022, and it announced a standard for IoT devices, Matter, the aim of which is to develop open source standard for IoT communication. WiFi and Thread are at its core, with WiFi supporting the high bandwidth cloud needs and Thread providing energy efficient and reliable local mesh capability. Numerous IoT devices are in the process of getting Matter certification.

Most drone mesh networks leverage IEEE 802.11 standards for implementing the mesh network and Better Approach to Mobile Ad hoc Networking (BATMAN) for the routing protocol. A summary of some of these drone mesh networks is provided below.

Chand et al. (“Drone based wireless mesh network for disaster/military environment,” Journal of Computer and Communications, 2018) developed a customized wireless mesh network using OM2P and MR1750 mesh nodes where OM2P supports IEEE 802.11n and MR1750 supports IEEE 802.11ac standard. The nodes use Open-WRT as their operating system. Chand et al. used a quadcopter and mounted their indigenous mesh nodes on the drone. Routing for the mesh network was enabled by BATMAN-advanced routing protocol. Out of the three-node topology, one of the nodes acted as a WiFi Access Point in the implementation.

Meshmerize (Pandi et al. “MESHMERIZE: An interactive demo of resilient mesh networks in drones,” in 2019 16th IEEE Annual Consumer Communications & Networking Conference (CCNC), 2019) is an opportunistic multi-path routing protocol for dynamic mesh networks. Pandi et al. used IEEE 802.11n WiFi modules to implement the mesh network. Further, Pandi et al. tested the developed mesh network with 4 nodes in which one of them is an outdoor drone. The drone is installed with a Raspberry Pi Zero that has a video camera broadcasting the video stream over Meshmerize protocol to all receiving stationary nodes.

ASTRO (R. Petrolo et al., “ASTRO: A System for Off-grid Networked Drone Sensing Missions,” ACM Transactions on Internet of Things, 2021) is a system that is able to sense distributed missions with the help of autonomous networked drones. ASTRO hexadrones are installed with IRIS Software Defined Radio boards for networking capabilities and use BATMAN for enabling the routing. Their study is limited to a single hop; but, authors claim that multihopping can be done (evaluation not presented).

DANGER (Coletta et al., “DANGER: a drones aided network for guiding emergency and rescue operations,” in Proceedings of the Twenty-First International Symposium on Theory, Algorithmic Foundations, and Protocol Design for Mobile Networks and Mobile Computing, 2020) is a system of connected drones that are equipped with one Raspberry Pi and multiple WiFi antennas. While one of the antennas aids in establishing connection between Raspberry Pi and drone to enable remote control of the drone, another antenna aids in enabling the mesh network connectivity over BATMAN protocol. A third antenna is used for connecting the drone with a smartphone. Coletta et al. demonstrated the use of DANGER with four flying drones with multi-hopping enabled.

HIRONET (Ferranti et al., “Hiro-net: Self-organized robotic mesh networking for internet sharing in disaster scenarios,” in IEEE 20th International Symposium on A World of Wireless, Mobile and Multimedia Networks (WoWMoM), 2019) is a system of drones connected to a BLE mesh network on ground. The drones in HIRONET get to the Internet with long range VHF links with the help of goTennas. Ferranti et al. leveraged Overlay Network Protocol for enabling the interaction between BLE mesh and VHF mesh links. HIRONET can be used in emergency scenarios where low-bit-rate data transmission is needed such as, a text, a tweet, or an email message.

UAVNet (Morgenthaler et al., “UAVNet: A mobile wireless mesh network using unmanned aerial vehicles,” in IEEE globecom workshops, 2012) is a system for connecting drones in an IEEE 802.11s WiFi mesh network with the help of OMIP, and these drones connect to ground nodes over IEEE 802.11g WiFi links. UAVNet was evaluated with multiple drones flying. Discussion of routing was not presented in this paper.

Laclau et al. (“Signal-based self-organization of a chain of uavs for subterranean exploration,” Frontiers in Robotics and AI, 2021) present a distributed algorithm named U-Chain to organize a mesh chain of flying robots, such as drones. The algorithm primarily works with the measured received signal strength to decide when a new drone should fly and bridge the connectivity gap to avoid the connection outage. The major use case disclosed by Laclau et al. was exploration of subterranean environments, such as caves. Laclau et al. used CrazyFlies 2.X with their default CrazyRadio WiFi capability to enable the mesh connectivity.

While providing mesh networking across drones, these works exhibit the following limitations. First, most of these works rely on special communication devices that are expensive. For example, a goTenna mesh costs around $200 per node, USRP SDR Boards cost approximately $3000 (but can cost many more thousands based on the board capability), and OpenMesh routers cost about $100 per node. Second, the systems presented above are all developed for outdoor environments and do not meet the low power and no-GPS requirements of indoor IoT networks. Third, these systems do not provide the feature of connectivity to the outside world.

### BRIEF SUMMARY OF THE INVENTION

According to embodiments of the present disclosure, a reliable low power IoFT network has been developed by fusing the potential of low-power mesh networking provided by Thread protocol with that of flying drones. As will be discussed more fully below, Thread is a protocol that enables low power IPv6 mesh connectivity that relies on IEEE 802.15.4. Thread has been shown to scale well with several hundreds of devices, provide extremely dynamic network topology, and is also power efficient. Thread architecture decouples routing and low power data transmission and, thus, is able to sustain a robust mesh network. An open source version of the Thread protocol, OpenThread, has been developed, and in experimental examples provided herein, OpenThread is leveraged to create, maintain, and manage the presently disclosed IoFT network. In particular, a prototype of an IoFT network with Thread devices mounted on drones was built such that the drones can communicate with the help of the Thread devices. The disclosed IoFT network (also referred to herein as “drone mesh network”) enables ground-to-air, air-to-air, and air-to-ground connectivity. The networking performance of the developed IoFT network was evaluated by quantifying the throughput, latency, and resilience. To the best of the inventors' knowledge, the disclosed drone mesh network is one of the first practical demonstrations of a completely open source OpenThread-powered IoFT network. The inventors envision that a flying IoT network can be used for multiple high impact applications, and one such example used to frame the discussion is a disaster scenario in which a building is on fire and crucial building information is needed when human intervention is not possible.

In the following discussion, the inventors demonstrate an open source implementation of Thread protocol-OpenThread-to create an indoor IoFT mesh network. The operation of the Thread protocol is explained in detail as well as how OpenThread operates. Further, the inventors present the implementation details of the first known open source OpenThread-powered drone mesh network. Details of the experimental setup, including four drones acting as IoFT nodes and two ground IoT nodes that communicate with each other via the IoFT network, are provided. Additionally, with carefully architected topologies, the inventors demonstrate the operation of the developed IoFT network and evaluate the performance of the network for metrics such as throughput, latency, and resilience.

Still further, the presently disclosed mesh network utilizes comparatively low cost devices to establish communication between the drones. In particular, experimental embodiments utilize NRF52840 MDK chips that are available for $14 or less per chip. Further, as mentioned, the mesh network is established using an open source implementation of the Thread protocol, OpenThread, designed for low power IoT networks. This protocol enables IPv6 connectivity by default, providing connectivity to the outside world. Further, the Thread protocol (and its open source implementation OpenThread) is at the core of CSA's Matter, which the standard for upcoming IoT networks. Thus, as this protocol takes precedence in the industry, the disclosed drone mesh network can be seamlessly integrated in OpenThread-based networks in a smooth manner.

In a first aspect, embodiments of the disclosure relate to a mesh network. The mesh network includes a plurality of drones and a border router. The plurality of drones is configured to communicate with each other and with the border router over a first protocol. The first protocol uses IPv6 mesh connectivity at a first bandwidth. At least one drone of the plurality of drones operates as a router, and at least one drone of the plurality of drones operates as an end device. The router is configured to communicate with the border router and with the end device, and the end device is configured to communicate only with the router. The border router is configured to communicate with an external network over a second protocol using a second bandwidth, and the second bandwidth is greater than the first bandwidth.

In a second aspect, embodiments of the disclosure relate to the mesh network of the first aspect in which the first bandwidth is 250 Kbps or less.

In a third aspect, embodiments of the disclosure relate to the mesh network of the first aspect or the second aspect in which the second bandwidth is at least 40 Kbps.

In a fourth aspect, embodiments of the disclosure relate to the mesh network of any of the first aspect to the third aspect in which a median network latency from the end device to the border router is 100 ms or less.

In a fifth aspect, embodiments of the disclosure relate to the mesh network of any of the first aspect to the fourth aspect in which the first protocol is Thread.

In a sixth aspect, embodiments of the disclosure relate to the mesh network of any of the first aspect to the fifth aspect in which the first protocol is configured to implement a new drone in the mesh network and update communication paths between the plurality of drones and the border router in 60 seconds or less.

In a seventh aspect, embodiments of the disclosure relate to the mesh network of any of the first aspect to the sixth aspect in which the plurality of drones are configured to move in topologies that avoid partitioning of the mesh network.

In an eighth aspect, embodiments of the disclosure relate to the mesh network of any of the first aspect to the seventh aspect in which each drone of the plurality of drones is battery powered and weighs 100 grams or less.

In a ninth aspect, embodiments of the disclosure relate to the mesh network of any of the first aspect to the eighth aspect in which each drone of the plurality of drones can be equipped with a sensor selected from a group consisting of a light sensor, a proximity detector, a camera, a temperature sensor, a humidity sensor, a smoke or gas detector, and combinations thereof.

In a tenth aspect, embodiments of the disclosure relate to the mesh network of any of the first aspect to the ninth aspect in which each drone of the plurality of drones is capable of operating as a router and as an end device and in which the first protocol determines whether each drone operates as a router or as an end device.

In an eleventh aspect, embodiments of the disclosure relate to a method. In the method, a mesh network of a plurality of drones and a border router is deployed. Communication is established across the plurality of drones and the border router according to a first protocol, and the first protocol uses IPv6 mesh connectivity at a first bandwidth. At least one drone of the plurality of drones is assigned to be a router, and at least one drone of the plurality of drones is assigned to be an end device. Communications from the end device to the border router are relayed using the router. An external network is communicated with using the border router according to a second protocol, and the second protocol has a second bandwidth that is greater than the first bandwidth.

In a twelfth aspect, embodiments of the disclosure relate to a method according to the eleventh aspect in which sensor data is collected using the plurality of drones and in which relaying communications further comprises relaying the sensor data to the border router using the router.

In a thirteenth aspect, embodiments of the disclosure relate to the method of the twelfth aspect in which the sensor data can be collected using a sensor selected from a group consisting of a light sensor, a proximity detector, a camera, a temperature sensor, a humidity sensor, a smoke or gas detector, and combinations thereof.

In a fourteenth aspect, embodiments of the disclosure relate to the method of any of the eleventh aspect to the thirteenth aspect in which deploying the plurality of drones further comprises deploying the plurality of drones in a building.

In a fifteenth aspect, embodiments of the disclosure relate to the method of the fourteenth aspect in which the building is on fire.

In a sixteenth aspect, embodiments of the disclosure relate to the method of any of the eleventh aspect to the fifteenth aspect in which the first bandwidth is 250 Kbps or less.

In a seventeenth aspect, embodiments of the disclosure relate to the method of any of the eleventh aspect to the sixteenth aspect in which the first protocol is Thread.

In an eighteenth aspect, embodiments of the disclosure relate to the method of any of the eleventh aspect to the seventeenth aspect in which a new drone is substituted for at least one drone of the plurality of drones and in which communication paths between the plurality of drones and the border router are reconfigured according to the first protocol in 60 seconds or less.

In a nineteenth aspect, embodiments of the disclosure relate to the method of any of the eleventh aspect to the eighteenth aspect in which partitioning of the plurality of drones in the mesh network is avoided.

In a twentieth aspect, embodiments of the disclosure relate to the method of any of the eleventh aspect to the nineteenth aspect in which the second protocol is WiFi.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 depicts a drone mesh network, according to an exemplary embodiment;

FIG. 2 depicts scopes of addressability in mesh network implementing Thread protocol, according to an exemplary embodiment;

FIG. 3 depicts the deployment of the drone mesh network in the context of surveying a building fire, according to an exemplary embodiment;

FIG. 4 is a picture of a drone equipped with a chip configured to run the Thread protocol, according to an exemplary embodiment;

FIG. 5 is a schematic representation of an experimental setup for testing latency and throughput in a mesh network, according to an exemplary embodiment;

FIG. 6 is a graph of latency measured across the experimental setup of FIG. 5, according to an exemplary embodiment; and

FIG. 7 is a graph of throughput measured across the experimental setup of FIG. 5, according to an exemplary embodiment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Referring generally to the figures and to the following discussion, various embodiments of a drone mesh network are disclosed herein. In particular, the drone mesh network was developed using an open source IoT protocol that provides low power yet resilient networking. Through experimentation discussed below, the inventors demonstrate that the delay for data transmission across the drone network can be, on average, 100 ms or less, in particular 30 ms or less, with a throughput in a range of about 40 Kbps to 250 Kbps, in particular about 50 Kbps, while the drones are in motion, which provides sufficient bitrate for transmitting sensor data or messaging (e.g., texts, tweets, or emails). Further, when new drones are added to the network or drones in the network are removed or disabled, the network communication paths can be reconfigured in 60 seconds or less using the IoT protocol described herein. These and other aspects and advantages of the disclosed drone mesh network will be discussed in relation to the embodiments provided below and shown in the accompanying drawings. These embodiments are presented by way of illustration and not limitation.

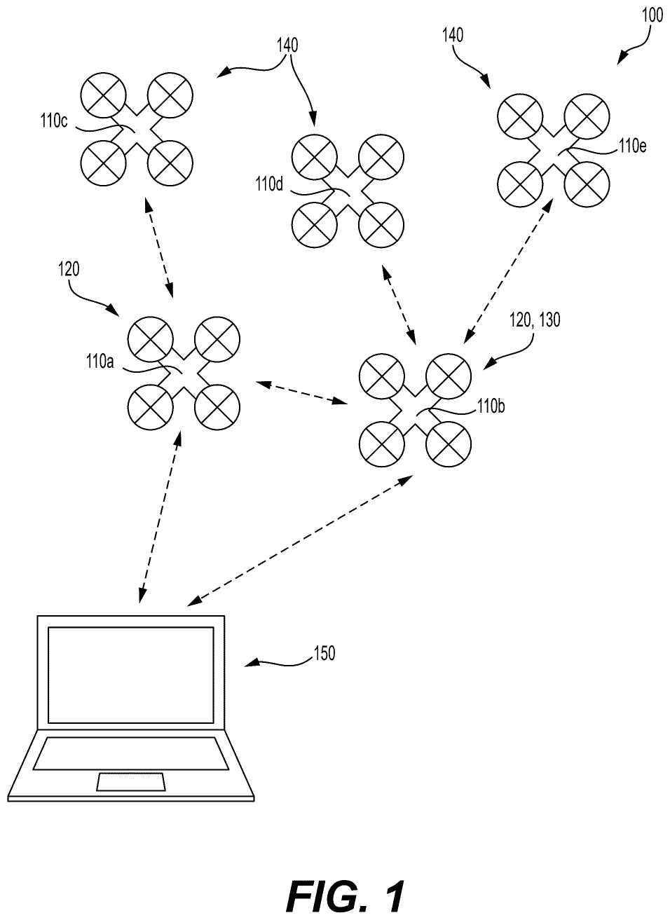

FIG. 1 depicts an example of a drone mesh network 100 according to an exemplary embodiment of the present disclosure. As can be seen in FIG. 1, the network 100 is comprised of a plurality of drones 110a-110e. In one or more embodiments, the drones 110a-110e can be any of a variety of different drones, such as single or multi-rotor designs (e.g., helicopter, quadcopter, hexacopter). Further, in one or more embodiments, the drones 110a-110e can be powered by any of a variety of power sources, such as batteries, photovoltaic cells, hydrogen fuel cell, or hydrocarbon fuel. In one or more particular embodiments, the drone is an indoor drone having a weight of 100 grams or less and is battery-powered. Additionally, the drones 110a-110e can be equipped with any of a variety of environmental sensors, including at least one of light sensors, proximity detector, cameras, temperature sensors, humidity sensors, smoke/gas detectors, or microphones, among other possibilities. In this way, the drones 110a-110e can be deployed to survey an environment and report information back to a user over the mesh network 100.

As shown in FIG. 1, the drones 110a-110e are in communication with each other in a mesh network topology. In one or more embodiments, the mesh network operates using an IPv6-based, low-power protocol. Further, the protocol is configured to avoid single points of failure and to provide the ability to self-heal. For example, the mesh network may operate using the Thread protocol. An example of an open source implementation of the Thread protocol in C programming is OpenThread. The Thread protocol uses 6LoWPAN, which in turn uses the IEEE 802.15.4 wireless protocol with mesh communication in the 2.4 GHZ spectrum. Further, these protocols are IP-addressable with cloud access and AES encryption.

As mentioned, OpenThread is the open source implementation of the Thread protocol. OpenThread maintained by Google and is primarily used by Google Nest products. OpenThread supports System-on-Chip (SoC), Network CoProcessor (NCP), and Radio CoProcessor (RCP) designs. SoC design has both application layer and OpenThread core running on the same chip, and because of the low power consumption, the SoC design is advantageous for use as end user devices. In RCP design, the Thread core runs on the host computer, and a minimal MAC layer runs on the Thread chip. Though this requires the host computer to be always on, it gives the Thread node privilege of accessing host resources. In NCP design, OpenThread core is on the Thread chip and the application layer resides on the host computer. In contrast to the RCP mode, a host in NCP mode can sleep while the Thread device is actively involved in network communication. The Spinel protocol may be used for communication between the host computer and the Thread SoC device. Communication between host computer and the Thread SoC using the Spinel protocol is handled by the OpenThread Daemon or ot-daemon in RCP mode and by WPANTUND in NCP mode. An OpenThread border router operates in the RCP mode, and RCP mode is also the recommended mode for other nodes in the network.

According to OpenThread protocol, devices in the network may be one of the following types (although the type may change during operation): border router, leader, router, router eligible end device (REED), or end device. A border router provides connectivity services to the internal IEEE 802.15.4 network as well as to the adjacent networks executing on different physical layers, such as WiFi. The leader is the device that is responsible for managing the entire network, and in one or more embodiments, the leader is the border router or one of the drones that operates as a router. The leader is self-elected in a dynamic manner, decides which nodes can act as routers, and assigns addresses to routers and end-devices. For example, the first router active in the network may automatically elect itself as the leader, and subsequent routers that are activated and sense the leader will connect and become end devices. A subsequent router that is activated will either sense the leader and become an end device of the leader or sense an end device (REED), which will promote itself to a router while the new router will act as an end device.

The devices in the network may be a full Thread device (FTD) or a minimal Thread device (MTD). A FTD is a Thread device whose radio is always on. An FTD can take the role of a router, a REED, or a full end device (FED). A REED is an end device that can be promoted to a router, whereas a FED cannot be promoted to a router. A REED promotes itself to a router when it is the only node in the vicinity of an end-device that is willing to connect to the Thread network. A Router can be a parent to an end device, and when a router does not have any children, it downgrades itself to an end device. An MTD can be either a minimal end device (MED) or a sleepy end device (SED). The transceiver of a MED is always on, but the transceiver does not poll its parent for messages. A SED has its transceiver always off and turns on intermittently to poll its parent for messages.

In one or more embodiments of a network according to the present disclosure, all of the drones 110a-110e are REEDs. That is, all of the drones can be end devices, routers, or a leader as necessary to maintain network integrity. Notwithstanding, some drones 110a-110e may lose communication with the entire network and, in response, partition to form separate network partitions that are each led by their own leader. Likewise, if the drones 110a-110e are back in sensing range of each other, their networks will merge into one. A single Thread network can have 1 leader, 32 routers, and 511 end devices per router. In one or more embodiments, the drones 110a-110e are programmed to move in topologies designed to avoid creating partitions so as to maximize the energy budget of the drones 110a-110e.

In the embodiment shown in FIG. 1, drones 110a, 110b are routers 120 with drone 110b being self-elected as leader 130, and drones 110c, 110d, 110e are end devices 140. The border router 150, which provides connectivity to external networks, is depicted as a laptop, which may also be used to deploy and control the drones 110a-110e.

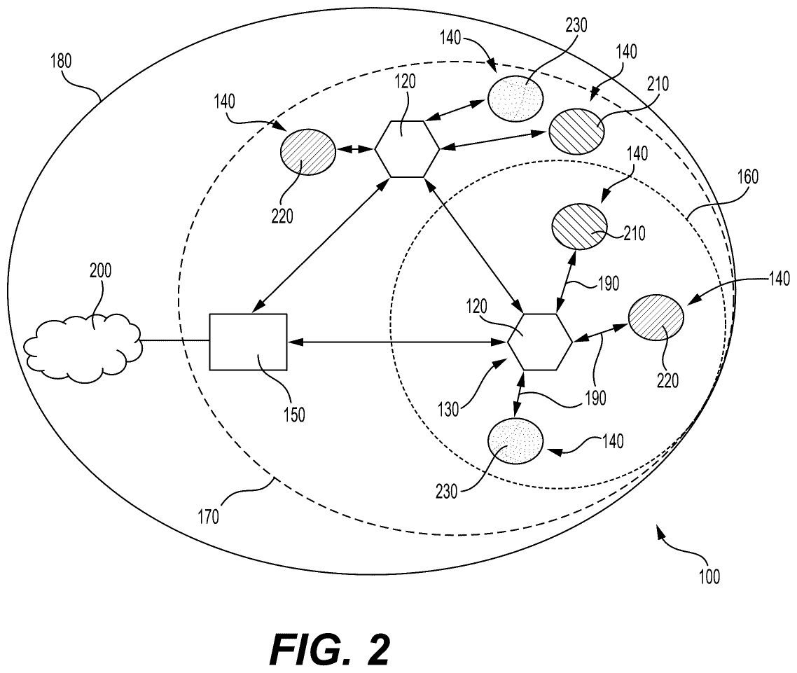

As shown in FIG. 2, nodes in a Thread network are addressable by IPv6 addresses that have 3 scopes: Link Local 160, Mesh Local 170, and Global 180. Link Local 160 addresses can be reached by direct link 190. Mesh Local 170 addresses can be reached by all nodes in the same Thread network, and Global 180 addresses can be reached by external networks (represented by cloud 200). Each device is further identified by a Routing Locator address called RLOC16. RLOC16 identifies a Thread node based on its location in the network. RLOC16 of an end device is assigned by a parent router, and so, if a child node changes its location, its RLOC16 address also changes. RLOC16 is used internally for routing purposes, and enduser applications use Mesh Local addresses.

As shown in FIG. 2, two routers 120 are connected to three end devices 140 each. In the embodiment depicted, one of the routers 120 was self-elected as leader 130. The end devices 140 include REEDs 210, MEDs 220, and SEDs 230. A router 120 and its connected end devices 140 define the Link Local scope 160. The Mesh Local scope 170 is defined by all of the routers 120, end devices 140, and border router 150. The Global scope 180 is provided by a link from the border router 150 to the cloud 200 or other external network.

Routing in Thread networks leverages a distance vector routing algorithm. Routers exchange Mesh Link Establishment (MLE) messages for neighbor discovery, sharing routing costs and establishing connections.

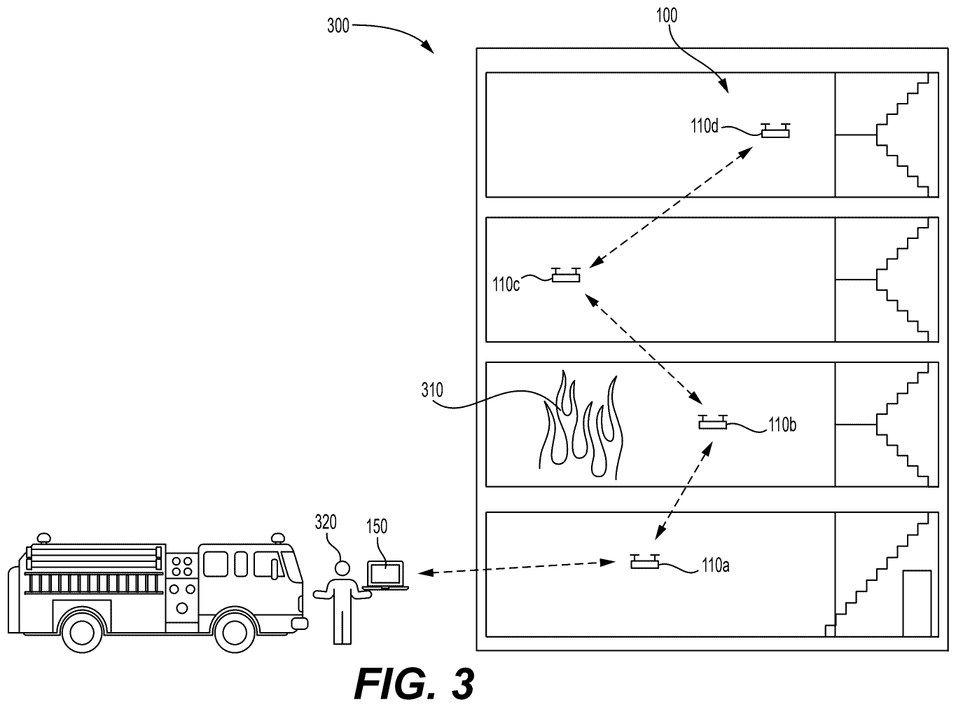

FIG. 3 depicts an example deployment of the drone mesh network 100, in particular to survey a building 300 that has experienced a disaster, such as a fire 310. Other disasters where the drone mesh network 100 can be deployed include collapsed buildings (e.g., from earthquakes or bombings), hazardous chemical spills, or other situations in which rescue workers may be at high risk. In the example embodiment depicted, the network 100 includes four drones 110a-110d. Drone 110a may be the leader 130, and drones 110a, 110b, 110c may act as routers 120 within the network 100. Drone 110d operates as an end device 140. As can be seen, drone 110a is in communication with the border router 150 controlled by a user 320, such as a firefighter responding to the fire 310. The drones 110a-110d may be equipped with various sensors, such as smoke detectors, humidity detectors, light sensors, and temperature sensors, such that, when the user 320 arrives at the scene, the drone mesh network 100 can be deployed for the drones to survey the building before any firefighters enter. In this way, the building 300 can be quickly surveyed to determine the location and extent of a fire 310. While not the focus of the present disclosure, path planning and object avoidance software for the drones 110a-110d facilitates the deployment of the drones 110a-110d in the building 300, and such software is known and commonly available, such as Aerostack2, described in Fernandez-Cortizas et al., “Aerostack2: A Software Framework for Developing Multi-robot Aerial Systems, arXiv: 2303.18237, 2023 (source code available at https://github.com/aerostack2/aerostack2).

Notably, the drone mesh network 100 does not rely on any infrastructure within the building 300. That is, the building 300 does not need to be equipped with any access nodes or routers to deploy the mesh network 100 and relay information to the user. In this way, the drone mesh network 100 can be deployed regardless of what building infrastructure may be damaged in the fire and without having to deploy infrastructure during a disaster. Using the information provided by the drone mesh network 100, users 320, such as firefighters, can be apprised of dangers within a building 300 (e.g., collapsed ceilings, blocked doorways, or intense heat/flames), the location of persons in need of help, and/or where to focus firefighting efforts from outside of the building 300.

Further, considering the possibility of significant structural damage and deteriorating conditions within the building, the disclosed drone mesh network 100 is resilient in that it can self-heal when drones are destroyed or otherwise knocked offline. Additionally, for battery-powered drones, drones can enter and leave the building as necessary for recharging, and the network will automatically reconfigure itself according to the Thread protocol.

The example context of a building disaster for the use of the drone mesh network 100 is merely exemplary. The drone mesh network 100 can be deployed in other indoor and outdoor environments. Other example contexts for the use of the drone mesh network 100 include smart building management (e.g., building occupancy detection) and path planning for visually impaired persons, among other possibilities.

### EXPERIMENTAL EXAMPLE

In order to test the effectiveness of the disclosed drone mesh network 100, drones were configured to operate according to the OpenThread protocol, and information was transferred across the mesh network. Further, the resiliency was tested by adding and removing drones from the network to confirm that the network would self-heal in a reasonable amount of time.

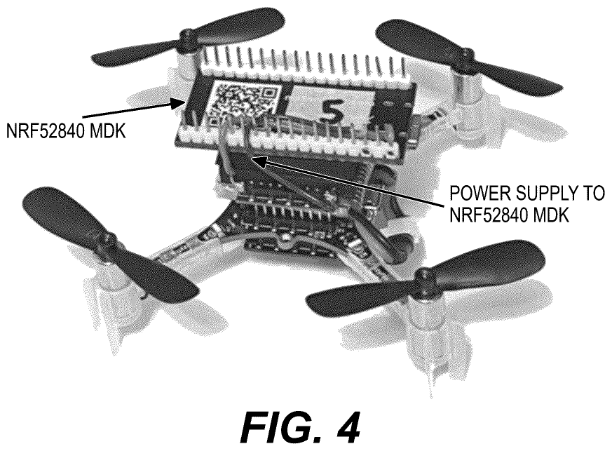

The drones for the mesh network were CrazyFlie 2.1 drones as shown in FIG. 4. Flow Deck v2.0 was installed on the drones for positioning of the drones. Additionally, each drone was equipped with an NRF52840 MDK chip (available from Nordic Semiconductor) as a Thread device. This chip was powered by the drone. In order to make sure that placement of the NRF52840-MDK chip did not negatively affect the aerodynamics of the CrazyFlie 2.1 drone, the placement of chip on the drone was carefully architected using small 3D printed frames to hold the chip. To fly multiple drones at the same time, a Python controller with multi-threaded programming was written.

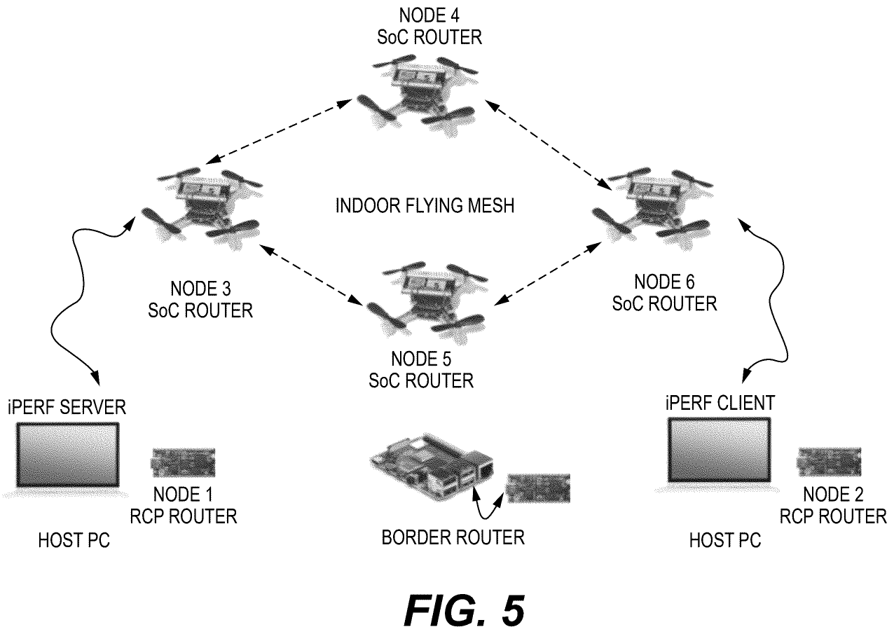

The mesh network for the experimental setup included two nodes on the ground and four nodes (drones) in the air. Ground nodes were interfaced to laptops with USB. These ground nodes were configured in RCP mode of OpenThread's operation. The air nodes were interfaced with drones. These air nodes were configured in SoC mode of OpenThread's operation. A border router was setup on a Raspberry Pi 3B+ node to ensure that all nodes got the same IPV6 Mesh Prefix. The border router also served as leader of the network for this experimental setup. FIG. 5 depicts the arrangement of the nodes in the experiment mesh network. Systems used in the experimental example were Linux based with Ubuntu 18.04.

The experiment evaluated the efficacy of a mesh network for its data transfer abilities. In the experimental setup, two ground OpenThread nodes tried to send data to each other via the multi-hop mesh network in the air. The performance of mesh network was tested in three different flying scenarios. In Scenario 1, both ground nodes were sending data to each other via the four drones that had not yet taken off. This scenario provided a baseline for network performance. In Scenario 2, the drones took off resulting in the ground nodes sending data to each other via the mesh network. This scenario established network performance when the drones were in the air. In Scenario 3, the dynamism of the flying mesh network was captured by simulating cases where network topology changed as a result of nodes changing positions, running out of battery, or getting damaged for any miscellaneous reason. In such a situation, routing paths will get updated, and the effect of these variations on the network performance was evaluated.

All experiments were conducted indoors in a lab space measuring 200 feet×100 feet. In order to test multihop transmission, the transmission power of the chips on each drone was limited to 20 feet based on the size of the lab space. In each scenario, network performance was evaluated with throughput and latency. Both ground nodes were equipped with iPerf utility to measure the UDP throughput and ping6 utility to measure the latency.

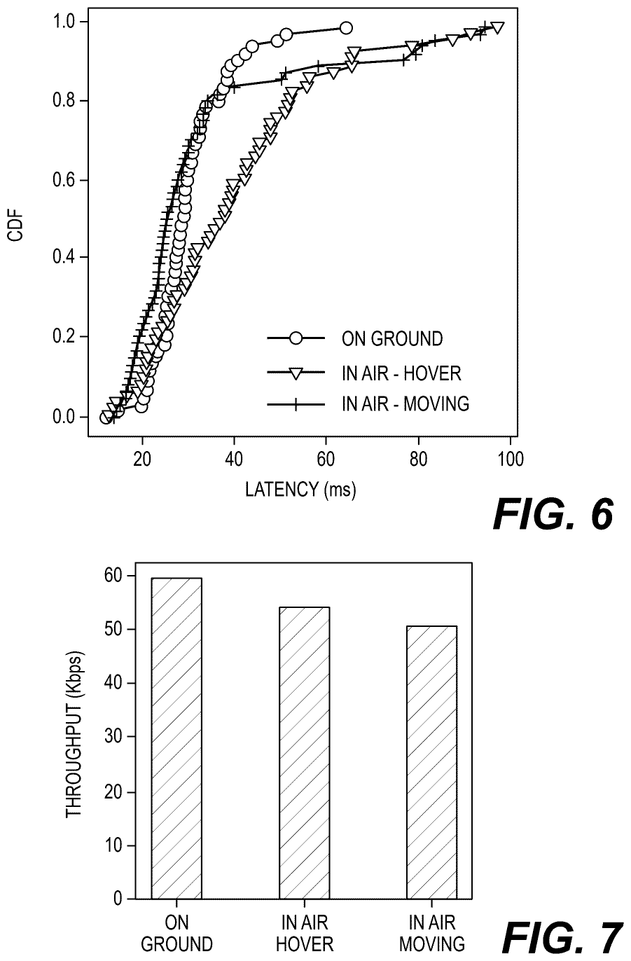

The latency and throughput results are summarized in FIGS. 6 and 7, respectively. In particular, FIG. 6 provides the cumulative distribution function (CDF) for the latency of data transmission from one ground node to the other across the mesh network, and FIG. 7 provides the UDP throughput (Kbps) for each of the three tested scenarios.

In Scenario 1, all nodes were on the ground, and it can be seen in FIG. 6 that the median latency in this scenario was approximately 30 ms with a maximum latency of 60 ms. As the drones take off in air in Scenario 2 and hover in their positions, the median latency increases to 40 ms with maximum latency of around 100 ms. Next, the drones were moved in a circular fashion in Scenario 3 to imitate the real-world situation where the drones are mobile. In this scenario, the standard deviation of latency increases from 8.06 ms when all nodes were on the ground to 16.28 ms when the drones were hovering and to 34.2 ms when the drones were moving. When drones are in the air, propeller movement introduces fluctuations in signal propagation, which explains the increase in latency with hovering. However, when the drones are mobile, the network experiences mixed states of good and bad connections. As a result, routing paths were affected, which explains the increased deviation in latency when the drones were moving.

As can be seen from FIG. 7, the network was able to achieve UDP throughput of 60 Kbps in Scenario 1, 55.95 Kbps in Scenario 2, and 50.5 Kbps in Scenario 3. With Scenario 2 and Scenario 3, network disruptions were introduced by impacting signal propagation with propeller movements. Thus, a drop in throughput is registered. While hovering does not impact routing paths, the motion of the drones, at times, affects the existing routing paths, resulting in a reduced network throughput for Scenario 3.

The resiliency of the mesh network was tested according to Scenario 3. In particular, the two ground nodes were first made to communicate over at least two hops in which the hops were in the air such that, if the routers died for any reason, connection between ground nodes would certainly break. Gradually, the intermediate routers were killed, and it was observed how much time it took to update the routing paths. Because the ground nodes were not in sensing range of each other, the two ground nodes never became part of one Thread network; instead, two distinct Thread partitions were created. Next, a new drone was introduced between the two ground nodes to heal the complete node failure, and the time for the new Thread device installed on the new drone to become part of the existing Thread network was measured. It took an average of 30 seconds for the new Thread node to join the network and update the routing paths before connectivity between the two ground nodes resumed.

To establish a baseline, the ground nodes were moved in the vicinity of each other after the intermediate router nodes died so that new routing paths could be established as soon as possible. The network took approximately 5 seconds to stabilize with the direct connectivity. The timeouts to re-establish connectivity between the nodes were averaged numbers as reported by the ping6 utility.

As demonstrated by the experiments presented above, OpenThread is a robust self-organizing protocol that is resilient to network failures and that can be used for mesh networks of drones. Such a network can be easily used in disaster scenarios, such as a building on fire, to collect vital ambient sensing values, amongst a multitude of other potential uses.

The Thread protocol is based on 6LoWPAN, which can sustain a maximum bitrate of 250 Kbps. The experimental setup established that, in flying scenarios, about 50 Kbps of UDP data can be sent, which is more than sufficient for a multitude of applications. For example, sensing ambient temperature with a temperature sensor and sending it to the cloud via the disclosed mesh network needs only a few bits per second. Further, the inventors used OpenThread to monitor physical distancing in classrooms where a few bytes of motion sensor data was sent to monitor the violation of physical distancing, which again establishes that high-impact use cases are possible with low bit rate capability of the developed mesh network. Advantageously, in the absence of infrastructure network, an OpenThread equipped smartphone can send messages of a few bytes to the cloud for enabling connections during an emergency. These messages can be simple text messages, tweets, or emails.

According to the Thread protocol, if two nodes go out of sensing range, they will create two different Thread partitions. This affects the routing and data transfer capability of the network. To merge two partitions, the nodes should either come back in range, or there should be another node in between them that could provide multi-hopping data transfer. On the ground, such multi-hopping is manageable, but in the air when power sensitive drones are flying, creation of network partitions is not friendly to the energy budget of the drone. Thus, the inventors envision that flying topologies can be created such that creation of network partitions are able to be avoided.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A mesh network, comprising:
a plurality of drones; and
a border router;
wherein the plurality of drones is configured to communicate with each other and with the border router over a first protocol, the first protocol using IPv6 mesh connectivity at a first bandwidth;
wherein at least one drone of the plurality of drones operates as a router and at least one drone of the plurality of drones operates as an end device, the router being configured to communicate with the border router and with the end device and the end device being configured to communicate only with the router; and
wherein the border router is configured to communicate with an external network over a second protocol using a second bandwidth, the second bandwidth being greater than the first bandwidth.

2. The mesh network of claim 1, wherein the first bandwidth is 250 Kbps or less.

3. The mesh network of claim 1, wherein the second bandwidth is at least 40 Kbps.

4. The mesh network of claim 1, wherein a median network latency from the end device to the border router is 100 ms or less.

5. The mesh network of claim 1, wherein the first protocol is Thread.

6. The mesh network of claim 1, wherein the first protocol is configured to implement a new drone in the mesh network and update communication paths between the plurality of drones and the border router in 60 seconds or less.

7. The mesh network of claim 1, wherein the plurality of drones is configured to move in topologies that avoid partitioning of the mesh network.

8. The mesh network of claim 1, wherein each drone of the plurality of drones is battery powered and weighs 100 grams or less.

9. The mesh network of claim 1, wherein each drone of the plurality of drones is equipped with a sensor selected from a group consisting of a light sensor, a proximity detector, a camera, a temperature sensor, a humidity sensor, a smoke or gas detector, and combinations thereof.

10. The mesh network of claim 1, wherein each drone of the plurality of drones is capable of operating as a router and as an end device and wherein the first protocol determines whether each drone operates as a router or as an end device.

11. A method, comprising:
deploying a mesh network of a plurality of drones and a border router;
establishing communication across the plurality of drones and the border router according to a first protocol, the first protocol using IPv6 mesh connectivity at a first bandwidth;
assigning at least one drone of the plurality of drones to be a router and at least one drone of the plurality of drones to be an end device;
relaying communications from the end device to the border router using the router; and
communicating according to a second protocol with an external network using the border router, the second protocol having a second bandwidth that is greater than the first bandwidth.

12. The method of claim 11, further comprising collecting sensor data using the plurality of drones, wherein relaying communications further comprises relaying the sensor data to the border router using the router.

13. The method of claim 12, wherein the sensor data is collected using a sensor selected from a group consisting of a light sensor, a proximity detector, a camera, a temperature sensor, a humidity sensor, a smoke or gas detector, and combinations thereof.

14. The method of claim 11, wherein deploying the plurality of drones further comprises deploying the plurality of drones in a building.

15. The method of claim 14, wherein the building is on fire.

16. The method of claim 11, wherein the first bandwidth is 250 Kbps or less.

17. The method of claim 11, wherein the first protocol is Thread.

18. The method of claim 11, further comprising substituting a new drone for at least one drone of the plurality of drones and reconfiguring communication paths between the plurality of drones and the border router according to the first protocol in 60 seconds or less.

19. The method of claim 11, further comprising avoiding partitioning of the plurality of drones in the mesh network.

20. The method of claim 11, wherein the second protocol is WiFi.
